(19) United States
(12) Patent Application Publication
(10) Pub. No.: US 2006/0171259 A1
(43) Pub. Date: Aug. 3, 2006

(54) Biasing member for securely connecting minute wheel and hour wheel for radio-controlled clocks

(76) Inventor: Tsai-Te Liu, Taoyuan City (TW)

Correspondence Address: LIN & ASSOCIATES INTELLECTUAL PROPERTY, P.O. BOX 2339, SARATOGA, CA, 95070-0339, US

(21) Appl. No.: 11/050,105

(22) Filed: Feb. 3, 2005

(51) Int. Cl. G04C 13/04; G04B 19/00

(52) U.S. Cl. 368/52

(57) ABSTRACT

A radio-controlled clock includes a separation board that includes a main shaft and a first shaft of the minute arm wheel is mounted to the main shaft. An hour arm wheel has a second shaft that is mounted to the first shaft. A biasing member having flexible extensions and each extension has a bending portion which a peak portion that is higher than the flat portion. The biasing member can be installed between the separation board and the minute arm wheel such that the peak portions are in contact with the minute arm wheel. The biasing member can be installed between the minute arm wheel and the hour arm wheel such that the peak portions are in contact with the minute arm wheel. The biasing member can be installed between the hour arm wheel and the casing of the clock such that the peak portions are in contact with the casing. The biasing member securely connects the parts together so as to avoid wearing during operation.

### FIELD OF THE INVENTION

The present invention relates to a radio-controlled clock, and more particularly, to a biasing member providing biasing force to securely connecting the minute arm wheel to the hour arm wheel.

### BACKGROUND OF THE INVENTION

A conventional radio-controlled clock generally includes a micro antenna, receiving chips, microprocessors, and driving mechanism. The standard time data received by the chips from the micro antenna is regulated and sent to the microprocessor which checks the data of the clock according to the standard time date. The driving mechanism is responsible the movement of the second, minute and hour arms. When checking with the standard time data, the second arm, minute arm and hour arm are initialized to zero position first and then adjusted to the correct positions. The initialized is made by using photoelectric sensors to precisely position the arms. Some radio-controlled clocks use two motors cooperated with two individual reduction gear sets to drive the gears in the clocks. Due to that the gears are engaged with each other so that the precise position for the driving gear is important during assembly stage.

The radio-controlled clocks include a separation board, a second arm wheel, a minute arm wheel, and an hour arm wheel. The second arm wheel and the minute arm wheel are respectively connected to two shafts on the separation board, and the hour arm wheel is then mounted to the shaft of the minute arm wheel. Nevertheless, due to the contact installation between the hour arm wheel and the minute arm wheel, wearing happens therebetween and affects the precision of the operation of the clock. Besides, when initializing the minute arm wheel and the hour arm wheel to zero, if the friction between the two wheels is not sufficient, the initial force of rotation could over rotate either of the two wheels.

Therefore, it is desired to increase the friction between the minute arm wheel and the hour arm wheel so as to reduce the slip movement between the two arm wheels to maintain the precision of the clocks.

### SUMMARY OF THE INVENTION

In accordance with an aspect of the present invention, there is provided a radio-controlled clock that comprises a separation board that includes a main shaft. A minute arm wheel has a first shaft that is mounted to the main shaft. An hour arm wheel has a second shaft that is mounted to the first shaft. A biasing member is mounted to the main shaft and two opposite surfaces of the biasing member are in contact with the separation board and the minute arm wheel.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 shows the structure of a radio-controlled clock in accordance with the present invention;

FIG. 2 is an exploded view to show a first embodiment of the biasing member, the minute wheel, and the hour wheel of the present invention;

FIG. 3 is an exploded view to show a second embodiment of the biasing member, the minute wheel and the hour wheel of the present invention, and

FIG. 4 is an exploded view to show a third embodiment of the biasing member, the minute wheel, and the hour wheel of the present invention.

### DETAILED DESCRIPTION OF THE PREFERRED EMBODIMENT

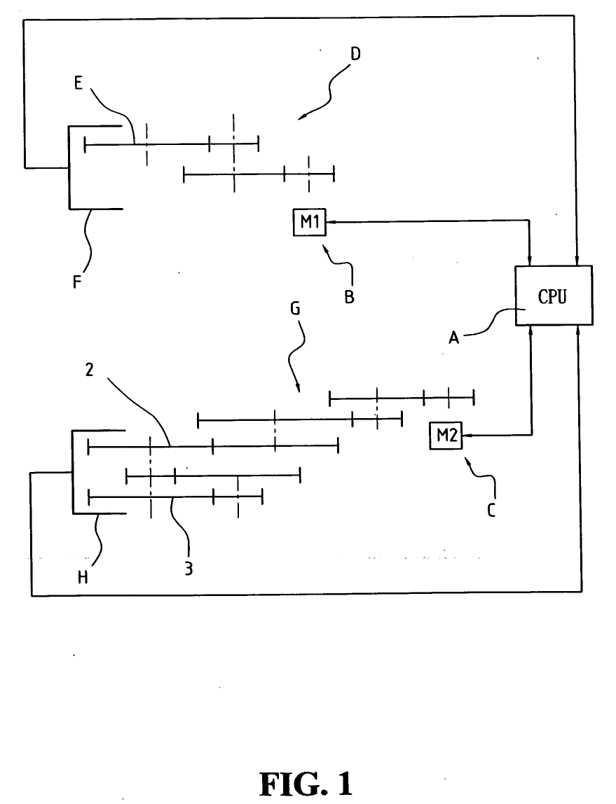

Referring to the drawings and in particular FIG. 1 which shows a radio-controlled clock having two driving motors including a first step motor “B” which drives a second arm wheel “E” via a reduction gear set “D” and a second step motor “C” which drives a minute arm wheel 2 and a hour arm wheel 3 via a reduction gear set “G”. A photoelectric sensor “F” is located beside the second arm wheel “E” and another photoelectric sensor “H” is located beside the minute arm wheel 2 and the hour arm wheel 3. These photoelectric sensors “F” and “H” check holes defined through the second arm wheel “E”, the minute arm wheel 2 and the hour arm wheel 3 to initialize them to zero. All the parts mentioned above are installed in a core of the clock and the shafts of the second arm wheel, the minute arm wheel and the hour arm wheel extend out from the core so as to respectively connect the arms.

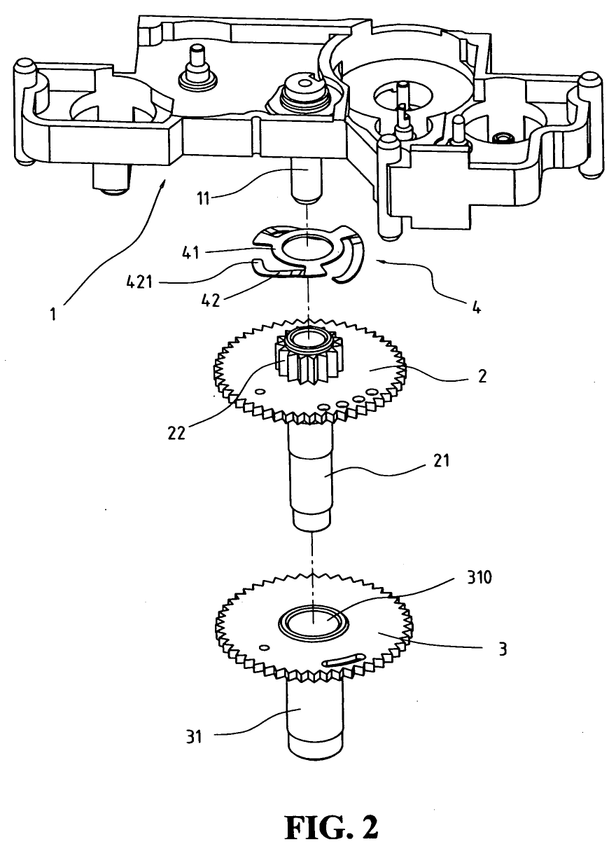

As shown in FIG. 2, the radio-controlled clock includes a separation board 1 for a platform of installation of the parts of the clock. A main shaft 11 extends from the separation board 1. The minute arm wheel 2 includes a first shaft 21 that includes a through hole defined axially therein and the main shaft 11 is inserted in the through hole of the first shaft 21. The hour arm wheel 3 has a second shaft 31 that includes a passage 310 defined axially therein. The first shaft 21 is inserted in the passage 310. A gear 22 is co-axially connected with the minute arm wheel 2 and engaged with the reduction gear set “G” so that the minute arm wheel 2 can be driven and the hour wheel 3 is co-rotated with the minute arm wheel 2. However, due to the friction between the minute arm wheel 2 and the hour arm wheel 3, wearing happens and the two shafts 21 and 31 might have relative slip-movement, which affects precision between the minute arm wheel 2 and the hour arm wheel 3. Especially when initialization to zero, the slip-movement results in imprecision.

FIG. 2 shows a first embodiment of the present invention wherein a biasing member 4 is provided and comprises a flat portion 41 from which three flexible extensions 42 extend outwardly. The flat protion 41 is in a form of a ring. Each extension 42 includes a bending portion that is bent upward and the peak portion 421 on each extension 42 is higher than the flat portion 41. The biasing member 4 is made by way of punching from a thin metal sheet. The extensions 42 provide biasing force to increase the friction between the minute arm wheel 2 and the hour arm wheel 3.

The biasing member 4 is mounted to the main shaft 11 by extending the main shaft 11 through the ring of the flat portion 41. The main shaft 11 is inserted in the through hole in the first shaft 21, which is then inserted in the passage 310 in the second shaft 31. The biasing member 4 is sandwiched between the separation board 1 and the minute arm wheel 2. Preferably, the flat portion 41 is in contact with the separation board 1 and the peak portions 421 of the extensions 42 are in contact with the surface of the minute arm wheel 2 so that the biasing force is applied to the minute arm wheel 2 to increase the friction between the minute arm wheel 2 and the hour arm wheel 3.

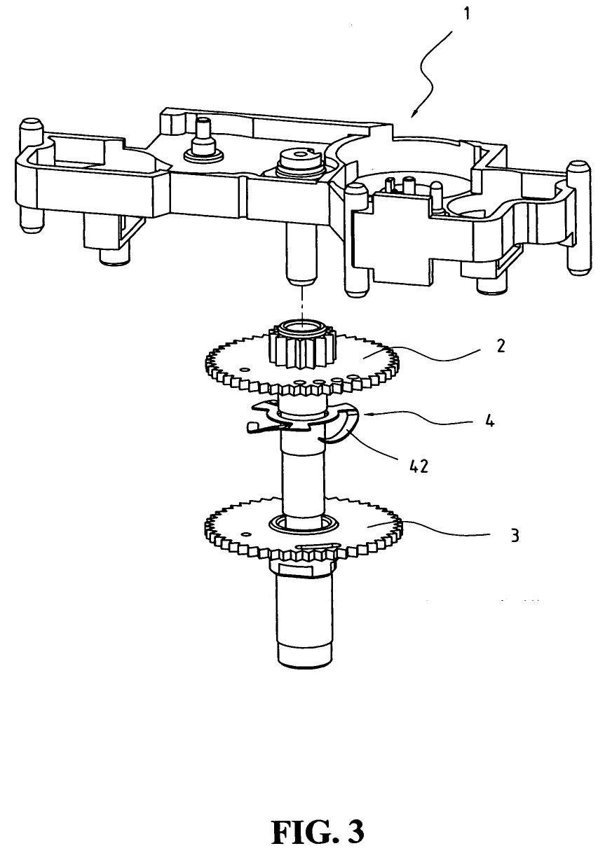

FIG. 3 show a second embodiment of the present invention wherein the main shaft 11 is inserted in the through hole in the first shaft 21 first and the biasing member 4 is then mounted to the first shaft 21 by extending the first shaft 21 through the ring of the flat portion 41. The first shaft 21 is then inserted in the passage 310 in the second shaft 31. The biasing member 4 is sandwiched between the minute arm wheel 2 and the hour arm wheel 3. Preferably, the flat portion 41 is in contact with the minute arm wheel 2 and the peak portions 421 of the extensions 42 are in contact with the surface of the hour arm wheel 3 so that the biasing force is applied to the minute arm wheel 2 and the hour arm wheel 3 to increase the friction between the minute arm wheel 2 and the hour arm wheel 3.

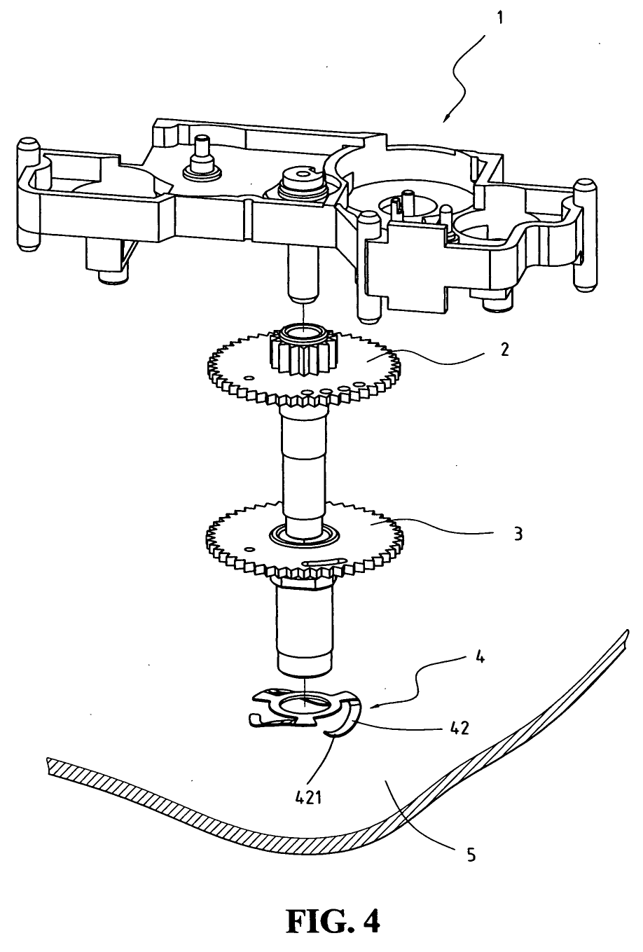

FIG. 4 show a third embodiment of the present invention wherein the main shaft 11 is inserted in the through hole in the first shaft 21 first and the first shaft 21 is then inserted in the passage 310 in the second shaft 31. The biasing member 4 is mounted to the second shaft 31 by extending the first shaft 21 through the ring of the flat portion 41. The second shaft 31 is then installed to the casing 5. The biasing member 4 is sandwiched between the hour arm wheel 3 and casing 5. Preferably, the flat portion 41 is in contact with the surface of the casing 5 and the peak portions 421 of the extensions 42 are in contact with the surface of the hour arm wheel 3 so that the biasing force is applied to the hour arm wheel 3 to increase the friction between the minute arm wheel 2 and the hour arm wheel 3.

While we have shown and described the embodiment in accordance with the present invention, it should be clear to those skilled in the art that further embodiments may be made without departing from the scope of the present invention.

What is claimed is:

1. A radio-controlled clock comprising:
a separation board which includes a main shaft;
a minute arm wheel having a first shaft which is mounted to the main shaft, an hour arm wheel having a second shaft which is mounted to the first shaft, and
a biasing member mounted to the main shaft and two opposite surfaces of the biasing member being in contact with the separation board and the minute arm wheel.

2. The clock as claimed in claim 1, wherein the biasing member has a flat portion which is in a form of a ring and a plurality of flexible extensions extend outward from the ring, each extension having a bending portion that is bent upward and higher than the flat portion.

3. The clock as claimed in claim 2, wherein the biasing member has three extensions and the peak portions of the extensions are located on a plane parallel with the flat portion.

4. The clock as claimed in claim 2, wherein the peak portions of the extensions are in contact with a surface of the minute arm wheel.

5. A radio-controlled clock comprising:
a separation board which includes a main shaft;
a minute arm wheel having a first shaft which is mounted to the main shaft, an hour arm wheel having a second shaft which is mounted to the first shaft, and
a biasing member mounted to the minute shaft and two opposite surfaces of the biasing member being in contact with the minute arm wheel and the hour arm wheel.

6. The clock as claimed in claim 5, wherein the biasing member has a flat portion which is in a form of a ring and a plurality of flexible extensions extend outward from the ring, each extension having a bending portion that is bent upward and higher than the flat portion.

7. The clock as claimed in claim 6, wherein the biasing member has three extensions and the peak portions of the extensions are located on a plane parallel with the flat portion.

8. The clock as claimed in claim 6, wherein the peak portions of the extensions are in contact with a surface of the hour arm wheel.

9. A radio-controlled clock comprising:
a separation board which includes a main shaft;
a minute arm wheel having a first shaft which is mounted to the main shaft, an hour arm wheel having a second shaft which is mounted to the first shaft, the second shaft being installed on a casing, and
a biasing member mounted to the hour shaft and two opposite surfaces of the biasing member being in contact with the hour arm wheel and a surface of the casing.

10. The clock as claimed in claim 9, wherein the biasing member has a flat portion which is in a form of a ring and a plurality of flexible extensions extend outward from the ring, each extension having a bending portion that is bent upward and higher than the flat portion.

11. The clock as claimed in claim 10, wherein the biasing member has three extensions and the peak portions of the extensions are located on a plane parallel with the flat portion.

12. The clock as claimed in claim 10, wherein the peak portions of the extensions are in contact with the surface of the casing.
